(19) United States
(12) Patent Application Publication
(10) Pub. No.: US 2025/0298515 A1
(43) Pub. Date: Sep. 25, 2025

(54) LOW-OVERHEAD PERIODIC ADJUSTMENT FOR MEMORY TIMING

(71) Applicant: Advanced Micro Devices, Inc., Santa Clara, CA (US)

(72) Inventors: Tsun-Ho Liu, Santa Clara, CA (US); Anwar Kashem, Santa Clara, CA (US)

(21) Appl. No.: 18/614,187

(22) Filed: Mar. 22, 2024

(51) Int. Cl. G06F 3/06

(52) U.S. Cl. CPC G06F 3/0619; G06F 3/0659; G06F 3/0673

(57) ABSTRACT

In an implementation, a memory subsystem may include input/output (I/O) circuitry having a data signal (DQ) group, the DQ group having multiple DQ lanes and a read data strobe, and one or more controllers coupled to the I/O circuitry, the one or more controllers being configured to assign, respectively to multiple DQ lanes of the DQ group, multiple read test delays that monotonically increase with respect to a read eye edge, read a read test value one time, using the DQ group, with the multiple read test delays respectively for each DQ lane in the DQ group, and update the read eye edge by adding a first read test delay, corresponding to a first DQ lane of the DQ lanes from the read test value that does not match a read eye training pattern, to the read eye edge to calculate a trained read eye edge.

### BACKGROUND

Computer systems utilize memory for storing data that is made accessible to a processor. The operating speed of a memory device, also referred to as throughput bandwidth, can at least in part determine the operating speed of the processor in a computer system. Modern dynamic random-access memory (DRAM), typically in the form of dual-inline memory modules (DIMM) provides high memory throughput bandwidth by increasing the speed of data transmission on a bus connecting the DRAM and one or more data processors, such as central processing units (CPUs), graphics processing units (GPUs), among others.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a depiction of a DDR memory subsystem in accordance with some implementations;

FIG. 2 is a depiction of a DDR channel interface in accordance with some implementations;

FIG. 3 is a timing diagram of DDR strobe group timing in accordance with some implementations;

FIG. 4 is a depiction of a timing eye diagram in accordance with some implementations;

FIGS. 5A and 5B are respective depictions of timing eye diagrams in accordance with some implementations; with some implementations;

FIG. 7 is a flow chart of a method for data training in accordance with some implementations;

FIG. 8 is a flow chart of a method for data eye training in accordance with some implementations;

FIG. 9 is a depiction of certain elements of an LPDDR5 system platform in accordance with some implementations;

FIGS. 10A and 10B collectively are a flow chart of a method for read data training in accordance with some implementations;

FIGS. 11A and 11B collectively are a flow chart of a method for write data training in accordance with some implementations;

Corresponding numerals and symbols in the different figures generally refer to corresponding parts unless otherwise indicated. The figures are drawn to clearly illustrate the relevant aspects of the implementations and are not necessarily drawn to scale. The edges of features drawn in the figures do not necessarily indicate the termination of the extent of the feature.

### DETAILED DESCRIPTION OF ILLUSTRATIVE IMPLEMENTATIONS

The making and using of various implementations are discussed in detail below. It should be appreciated, however, that the various implementations described herein are applicable in a wide variety of specific contexts. The specific implementations discussed are merely illustrative of specific ways to make and use various implementations, and should not be construed in a limited scope.

Reference to “an implementation,” “one implementation,” “an embodiment,” or “one embodiment” in the framework of the present description is intended to indicate that a particular configuration, structure, or characteristic described in relation to the implementation/embodiment is included in at least one implementation/embodiment. Hence, phrases such as “in one implementation” or “in one embodiment” that may be present in one or more points of the present description do not necessarily refer to one and the same implementation/embodiment. Moreover, particular conformations, structures, or characteristics may be combined in any adequate way in one or more implementations/embodiments. The references used herein are provided merely for convenience and hence do not define the extent of protection or the scope of the implementations/embodiments.

While various enhancements have improved the speed of DDR memory used for computer systems' main memory, further improvements are desirable. In particular, the memory throughput bandwidth involved with applications such as high-performance graphics processors and servers, which have multiple cores and a corresponding increase in throughput bandwidth-per-core, are increasing the performance demands for DDR DRAM chips. Improved DIMM architectures for current DDR chip technologies have been developed in modern DDR4 and DDR5 generational standards.

In order to ensure the correct throughput of data, modern DDR systems have employed calibration training of precise clock timing prior to operation. Over time, however, DDR data transmission systems can experience voltage or temperature drift indicating that the training should be repeated, which can involve undesirable overhead during normal operation.

As noted, one type of synchronous DRAM (SDRAM) that is widely used is double data rate memory (DDR). DDR uses both a rising clock edge and a falling clock edge to trigger memory operations, such as reads and writes. Thus, DDR memory can double the bandwidth or data throughput as compared to memories that only trigger once per clock cycle. However, as operating clock frequencies increase and as operating voltages decrease, the timing of DDR memory transfers is increasingly subject to errors from sources such as jitter or drift. The high throughput bandwidth in modern DDR4 and DDR5 generational standards can push the calibration envelope to ever tighter and tighter timing constraints. As a result, an amount of tolerable jitter or drift can become increasingly smaller and smaller for desired operation of DDR memory circuits.

The typical calibration training methods in DDR memory circuits include an initial calibration training for read/write operations that is executed upon startup, as will be described in further detail. For example, the initial calibration training for both read and write operations can include performing continuous streams of reads and writes that consume multiple clock and strobe cycles. Because the overhead for the initial calibration upon startup does not affect availability of the DDR memory circuit during normal operation, a larger overhead for the initial calibration may not have a significant adverse impact on overall performance. However, due to tighter timing constraints under ever increasing clock frequencies, a propensity for timing decalibration of read/write operations, whether due to jitter or drift or temperature effects, during operation after initialization is also increased. As a result of the timing decalibration, the operating stability of DDR memory circuits can be reduced, which is undesirable for adversely affecting memory quality, and ultimately, negatively impacting throughput bandwidth.

Therefore, newer and faster implementations of DDR memory circuits, such as DDR4 and DDR5, may more frequently experience conditions that indicate repeated calibration training during operation, referred to as “periodic training” or “PHY periodic training”, as compared to earlier generation DDR memory circuits. However, for periodic training, the calibration training as performed upon power up and initialization may indeed have an adverse impact on overall performance of the DDR memory circuit, due to the large overhead involved (e.g. multiple read and write cycles). Furthermore, if such periodic training is simply delayed or performed less frequently than indicated, then the likelihood of errors in read/write operations can remain undesirably high for longer periods of operation, such as outside of a desired tolerance band.

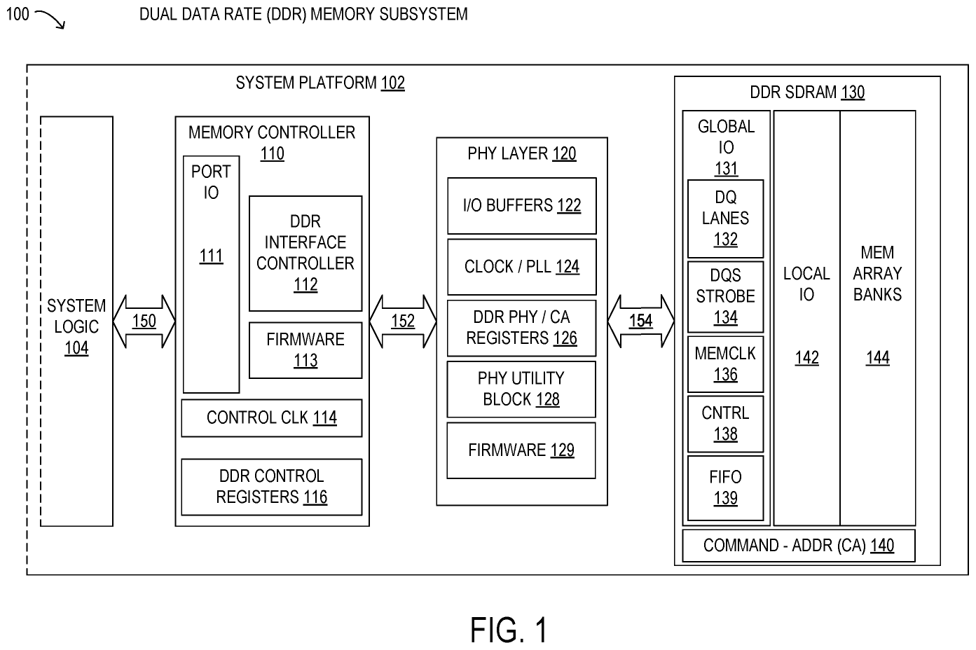

Referring now to the drawings, FIG. 1 depicts a DDR memory subsystem 100, referred to herein also simply as DDR subsystem 100 or subsystem 100. DDR subsystem 100 represents various target implementations of a data processing system that utilizes a DDR SDRAM 130 and is depicted in schematic form. Although various elements are depicted and described below with respect to DDR subsystem 100, it is noted that certain elements of a functional DDR subsystem, such a certain interconnections and various circuit elements, are omitted in FIG. 1 for descriptive clarity.

The data processing system is generally represented by a system platform 102 and a system logic 104 that can be elements in a larger system context. For example, in some implementations, system platform 102 can be an application specific integrated circuit (ASIC), a field-programmable gate array (FPGA), a system-on-chip (SOC), among other types of circuits. In other implementations, at least certain portions of system platform 102 can be implemented as a printed circuit board (PCB) that is populated with integrated circuits (ICs), such as a motherboard of a computer system that can have various form factors. In some implementations, system platform 102 and system logic 104 can represent at least certain portions of, or be associated with, a central processing unit (CPU), or main processor, of the computer system, such that DDR SDRAM 130 is a main memory accessible to the CPU. In some implementations, system platform 102 and system logic 104 can represent at least certain portions of, or be associated with, a graphics processing unit (GPU) that is a secondary processor of the computer system having DDR SDRAM 130 as working GPU memory. Accordingly, as shown in FIG. 1, an interface 150 between system logic 104 and a memory controller 110 can be a customized or proprietary interface that is specific to or depends upon a particular design of system logic 104, for example, rather than a standardized interface.

In DDR subsystem 100, memory controller 110, a PHY layer 120, and DDR SDRAM 130 are main elements that respond to memory commands from system logic 104 via interface 150, such as memory commands that convey address information as well as data from reading or for writing.

As shown in FIG. 1, memory controller 110 can be a DDR SDRAM-compatible memory controller. In some implementations, memory controller 110 can represent a stand-alone device, such as an IC, that populates a PCB that embodies system platform 102. In some implementations, memory controller 110 can be integrated as an intellectual property (IP) design resource into a native circuit design of system platform 102, such as when system platform 102 is a CPU or a GPU, for example. As shown in DDR memory subsystem 100, memory controller 110 includes a port IO in, a DDR interface controller 112 (or simply DDR controller (DDRC) 112), a firmware 113, a control clock 114, and DDR control registers 116.

In memory controller 110, port IO in can represent an endpoint of a communication bus and may comprise multiple port interfaces that communicate directly with other elements in system platform 102. For example, port IO in can support a communication bus protocol included with interface 150. In some implementations, port IO in is compatible with an on-chip communication bus protocol that is a referenced standard protocol, such as an advanced extensible interface (AXI), that can provide bus protocol handling, data buffering and reordering for read data, data bus size conversion, and memory burst address alignment. Port IO nil can serve as the interface to memory controller 110 and can perform DDR memory functions, such as read address generation, write address generation, write data generation, read data and response generation, write response generation. Port IO 111 can convert data bursts received via interface 150 into DDR SDRAM read and write requests that are handled by a port arbiter (not shown). The incoming read and write requests to port IO 111 are forwarded to DDR interface controller 112 from the port arbiter, and on to PHY layer 120 for sending to DDR SDRAM 130, as will be described in further detail below. In the opposite direction, responses from DDR SDRAM 130 via PHY layer 120 are converted at port IO 111 into compatible responses for interface 150. Port IO 111 and associated bus interfaces can operate synchronously to control clock 114. DDR interface controller 112 represents a circuit element that that can perform scheduling and SDRAM command generation and hold information on the SDRAM commands. DDR interface controller 112 can implement scheduling algorithms to optimally schedule commands to be sent to PHY layer 120 based on priority, bank/rank status, and DDR timing definitions. As will be explained in further detail, DDR interface controller 112 can also handle a controller initialization sequence involving PHY layer 120 initialization, DDR SDRAM 130 initialization, and data training. A firmware 113 can enable specific or customized functionality for DDR interface controller, such as for low-overhead periodic adjustment for memory timing disclosed herein, as will be discussed in further detail. Also shown included with memory controller 110 are DDR control registers 116 that can hold various control information and values.

In DDR memory subsystem 100, PHY layer 120 represents an interface module between memory controller 110 and DDR SDRAM 130. In FIG. 1, PHY layer 120 can be controlled or driven by memory controller 110 using an interface 152 and can control or drive DDR SDRAM 130 using an interface 154. In contrast to interface 150, interfaces 152, 154 can be standard interfaces with specified industry-standard connectivity to enable interoperability of different DDR components from various manufacturers. Specifically, interface 152 can represent a DDR PHY interface that is known as DFI and is promulgated by ddr-phy.org. The DFI specification defines an interface protocol between memory controller logic, such as memory controller 110, and PHY interfaces, such as PHY layer 120. DFI defines the signals, timing, and functionality required for efficient communication across PHY layer 120. The DFI specification is designed to be used by developers of both memory controllers and PHY designs, but does not place any restrictions on the how memory controller 110 interfaces to system logic 104, or how the PHY layer 120 interfaces to DDR SDRAM 130. Interface 154 between PHY layer 120 and DDR SDRAM 130 represents the main DDR SDRAM IO connections. Interface 154 can be a JEDEC standardized interface (Joint Electron Device Engineering Council (JEDEC), JEDEC Solid State Technology Association, jedec.org) such as the JESD79-4C SDRAM standard for DDR4 or the JESD79-5B SDRAM standard for DDR5. As shown, interface 154 handles communication and signaling for sending write data to DDR SDRAM 130 and for receiving read data from DDR SDRAM 130 under the control of PHY layer 120.

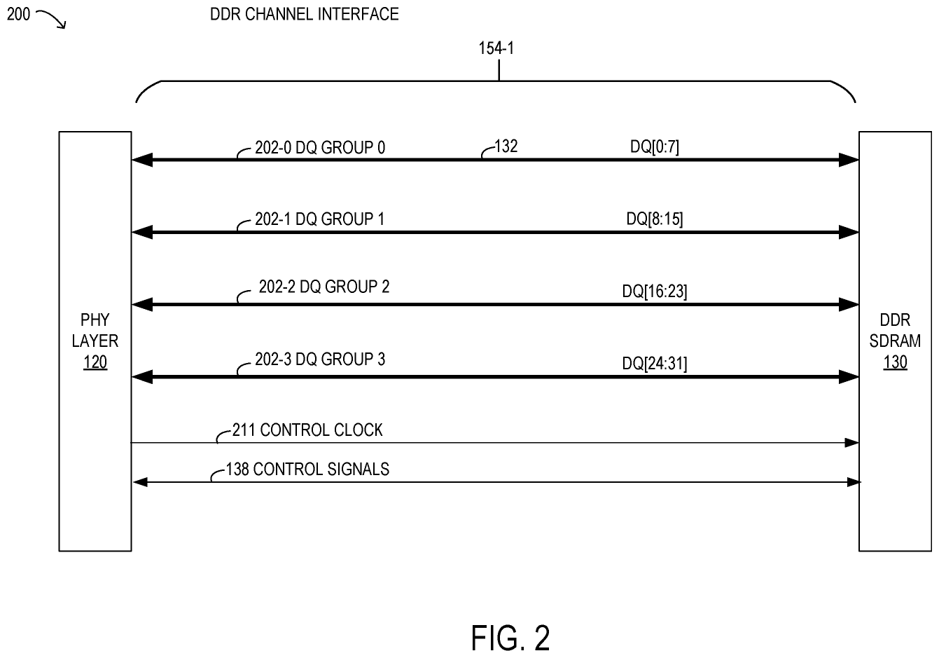

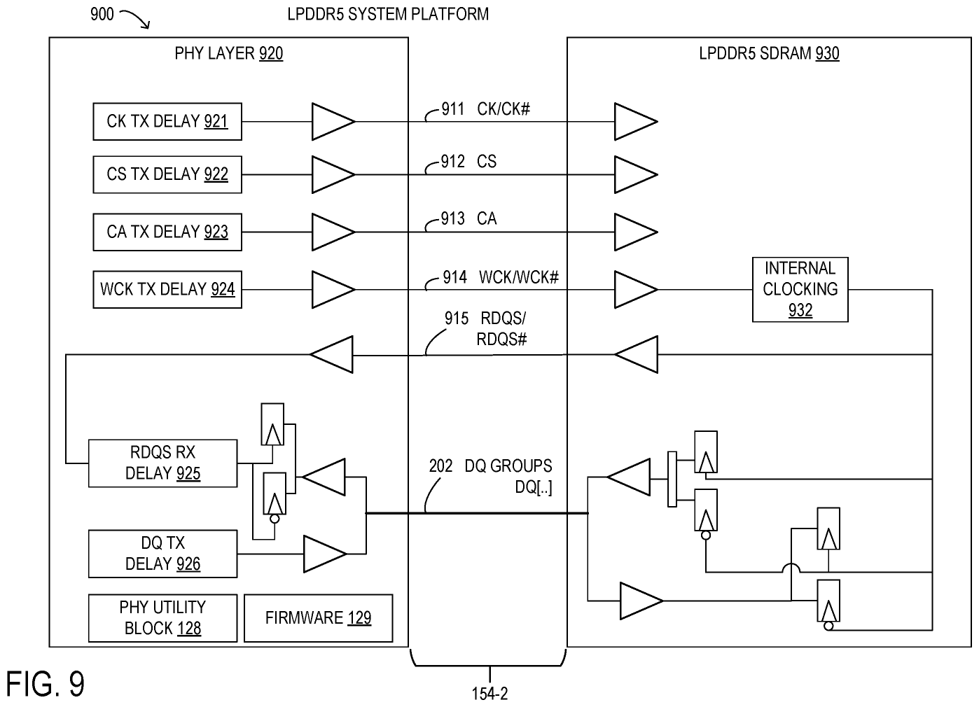

As shown in FIG. 1, PHY layer 120 includes I/O buffers 122 that can include respective buffers for address/command, data in 8-lane or 8-bit groups, clocking, and stub-series terminated logic (SSTL). PHY layer 120 also includes clock/PLL 124 that represents a DDR reference clock that can drive multiple phase-locked loops (PLL) that distribute the DDR reference timing, or a derivative thereof. In some implementations, clock/PLL 124 may use control clock 114 as input for synchronization. Certain implementation include clock/PLL 124 driving control clock 911 as a part of an interface 154-2 that DDR SDRAM 130 may use for synchronization, such as to drive internal clocking 932 (see FIG. 9). PHY layer 120 can output a control clock 211 (see FIG. 2) as part of interface 154 that can be driven by control clock 114 in some implementations. In certain implementations, PHY layer 120 can internally synthesize control clock 211 and make timing adjustments (see also CK/CK #911 in FIG. 9). For example, control clock 211 may represent control clock CK/CK #911 used in LPDDR5 in certain implementations. Thus, a memory clock 136 that is internal to DDR SDRAM 130 can be driven or synchronized with control clock 114 or control clock 211 or CK/CK #911 for the different strobe groups that are synthesized by DDR SDRAM 130, such as for data signal strobing using a DQS strobe 134 that is bidirectional, or a write clock WCK/WCK #914 and a read clock RDQS/RDQS #915 in LPDDR5 (see FIG. 9).

In PHY layer 120, DDR PHY/CA registers 126 can include registers to control clock/PLL 124 and command address data for command-address CA 140 in DDR SDRAM 130. A PHY utility block 128 can control various features of PHY layer 120, such as PHY initialization, data signal (DQ) gate training for global IO 131, delay line calibration and voltage threshold (VT) compensation, write leveling, and can include programmable configuration controls for data eye training, as will be described in further detail. PHY utility block 128 can also control and provide interface 152, which can be DFI. PHY utility block 128 may also handle operation of DDR PHY/CA registers 126. In particular implementations, PHY utility block 128 is enabled with processing capability, such as for executing code, such as represented by a firmware 129 that can store and provide access to executable code to PHY utility block 128.

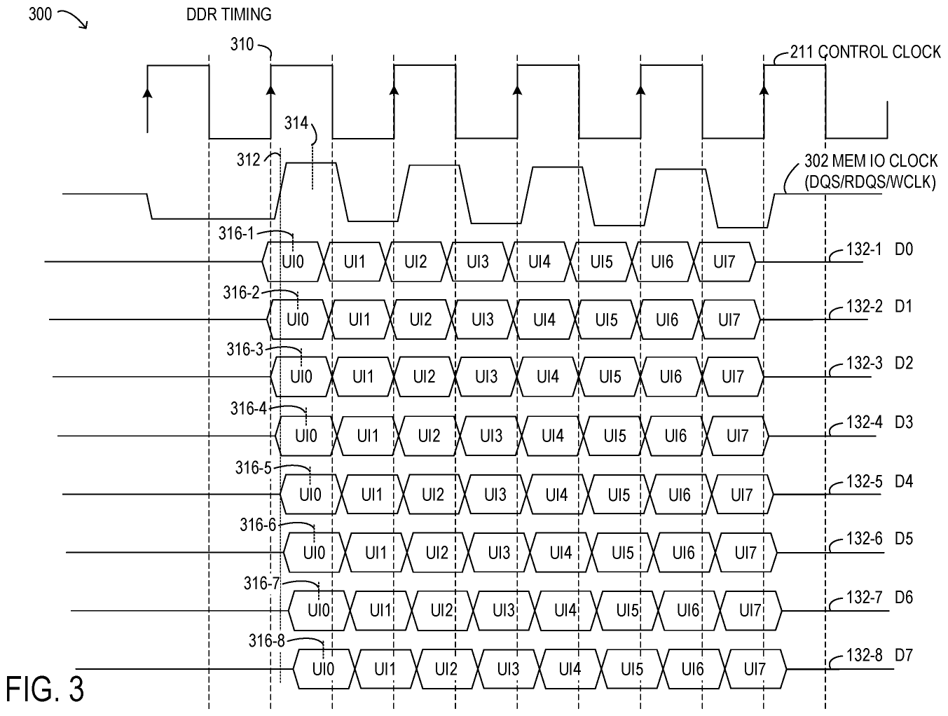

In FIG. 1, as noted, DDR SDRAM 130 depicts a volatile memory that is accessed by PHY layer 120 using interface 154. In some implementations, interface 154 is coupled to DDR SDRAM 130 by a physical connector, such as when DDR SDRAM 130 is implemented as a DIMM card that can populate the physical connector and is removable. In various implementations, DDR SDRAM 130 may be a modular DIMM or may be natively incorporated into system platform 102. As shown in FIG. 1, DDR SDRAM 130 includes various circuits including global IO 131, local IO 142, and memory array banks 144, along with command-address (CA) 140, which are registers for executing commands and sending address information to local IO 142. Global IO 131 represents the external interface for driving DDR SDRAM 130 that is enabled by interface 154 (see also FIG. 2). As shown, global IO includes data signal (DQ) lanes 132 which are signal lines for individual DQ groups having multiple DQ lanes or bits in each group, along with a DQS strobe 134 that provides timing for DDR read and write commands that is synchronized with memory clock 136 (see also FIG. 3) and generated internally by DDR SDRAM 130. Global IO 131 may further include circuitry or registers for control 138 representing command and address lanes that are controlled by command-address (CA) 140, which can be control registers.

For example, in FIG. 1, DDR SDRAM 130 can receive a READ command along with an address parameter to return the contents of a memory location in memory array banks 144 in response, and DDR SDRAM 130 can receive a WRITE command along with an address parameter and write date to write the write data to a memory location in memory array banks 144. Although shown as singular elements for descriptive clarity, local IO 142 and memory array banks 144 can be subdivided into multiple groups, such as four (4) groups, in various implementations, that operate on respective memory locations. Local IO 142 may accordingly include similar elements as global IO 131 for each respective group. In various implementations, local IO 142 and memory array banks 144 can be subdivided into two channels or ranks, each with multiple groups, such as in DDR5 memory. Memory array banks 144 can include arrays of banks with row and column decoders, along with sense amplifiers for maintaining and refreshing charge on capacitive memory elements in each bank.

Furthermore, as shown in FIG. 1, DDR SDRAM 130 can be implemented in various different configurations and implementations, such as for different types of applications, and include low power versions, which may. Specifically, the following standards (among others) have been defined by JEDEC: for DDR4 SDRAM—JESD79-4C; for DDR5 SDRAM—JESD79-5B; for low power DDR4 SDRAM LPDDR4—JESD209-4B; for low power DDR5 SDRAM LPDDR5—JESD209-5A.

Referring now to FIG. 2, a DDR channel interface 200 is depicted with signal lines included in interface 154-1 between PHY layer 120 and DDR SDRAM 130, in one implementation. As shown, interface 154-1 is one implementation of interface 154. As shown, DDR channel interface 200 includes four DQ groups 202 that each include eight (8) DQ lanes 132, respectively. For example, each DQ group 202 may carry one byte of a four-byte (32 bit) data value. Specifically, DQ group 0 202-0 carries DQ lanes 0:7; DQ group 1 202-1 carries DQ lanes 8:15; DQ group 2 202-2 carries DQ lanes 16:23; and DQ group 3 202-3 carries DQ lanes 24:31. In addition, interface 154-1 is shown carrying memory clock 136 and control signals 138 to global IO 131 (see FIG. 1). It is further noted that different configurations of interface 154 may be used in different implementations. Although, in the example implementations shown in FIGS. 2 and 3 and described in detail herein, DQ groups 202 are shown and described having eight (8) DQ lanes 132 (bits), in various implementations, DQ groups 202 can have different numbers of DQ lanes 132, such as four (4), sixteen (16), twenty four (24), and thirty two (32) DQ lanes, where each DQ group 202 can be associated with one DQ strobe 134 (e.g., an instance of memory IO clock 302). Furthermore, although not shown in FIG. 2, memory IO clock 302 may be generated by DDR SDRAM 130, such as by using PLLs driven by control clock 211 as a synchronization source (see also FIG. 3). Accordingly, in particular implementations, memory IO clock 302 may be included with DQ group 202 in DDR SDRAM 130, such as for the timing of read and write operations for data of memory array banks 144 (see FIG. 1), as disclosed herein.

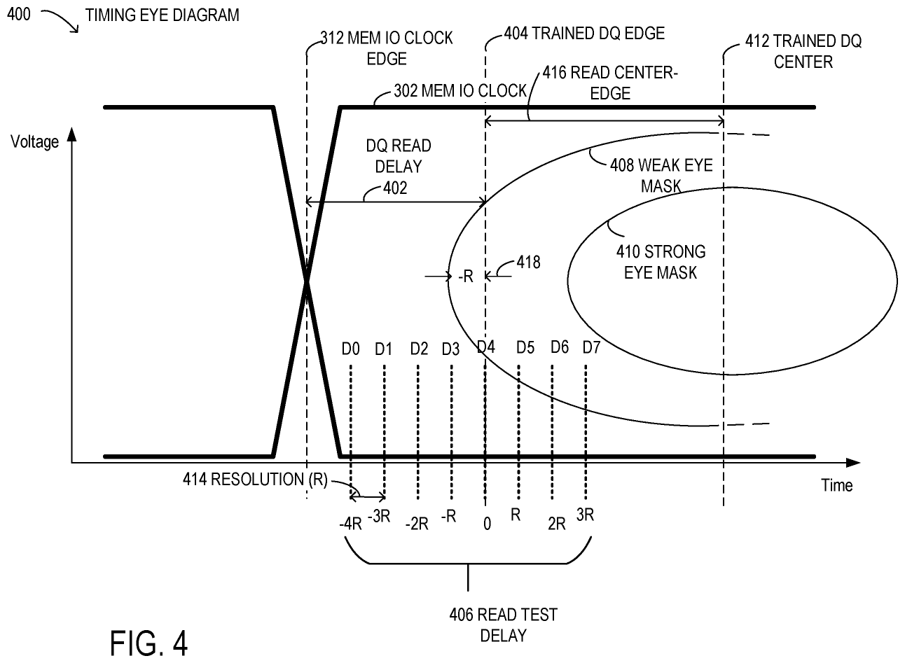

In FIG. 3, a timing diagram 300 of a DDR timing is depicted. Timing diagram 300 includes control clock 211 from interface 154, memory IO clock 302, and a group of eight (8) DQ lanes 132. Memory IO clock 302 can represent various internal timing clocks for DDR SDRAM 130 read or write operations in different implementations, such as DQS strobe 134, or write clock WCK/WCK #914 and read clock RDQS/RDQS #915 (also referred to as a read data strobe) used by internal clocking 932 (see FIG. 9). In FIG. 3, timing diagram 300 shows that DQ lanes 132 are transferred twice per period of control clock 211 and memory IO clock 302, on each rising edge and each falling edge, which is characteristic of DDR timing signals. It is noted that memory IO clock 302 may also have a different frequency than control clock 211, such as a higher frequency by a factor of 2, 4, 8, 16 etc. such that the transfer of DQ lanes 132 may be accelerated in certain implementations. Timing diagram 300 does not include DDR command and address signals for descriptive clarity and depicts timing relationships for DDR read and DDR write operations. Furthermore, control clock 211 and memory IO clock 302 are shown with a singular or true component, and do not show a complimentary component, such as when control clock 211 and memory IO clock 302 are differential clock signals, for descriptive clarity (see also FIGS. 4, 5A, 5B, and 9). Timing diagram 300 shows clocking timing for read or write transfer of 8 DQ lanes (bits) 132 labeled 132-1 D0, 132-2 D1, 132-3 D2, 132-4 D3, 132-5 D4, 132-6 D5, 132-7 D6, and 132-8 D7 in sequential order, representing transfer of 1 byte each. As noted, different numbers of DQ lanes per DQ group and per period of control clock 211 may be used or configured in different implementations.

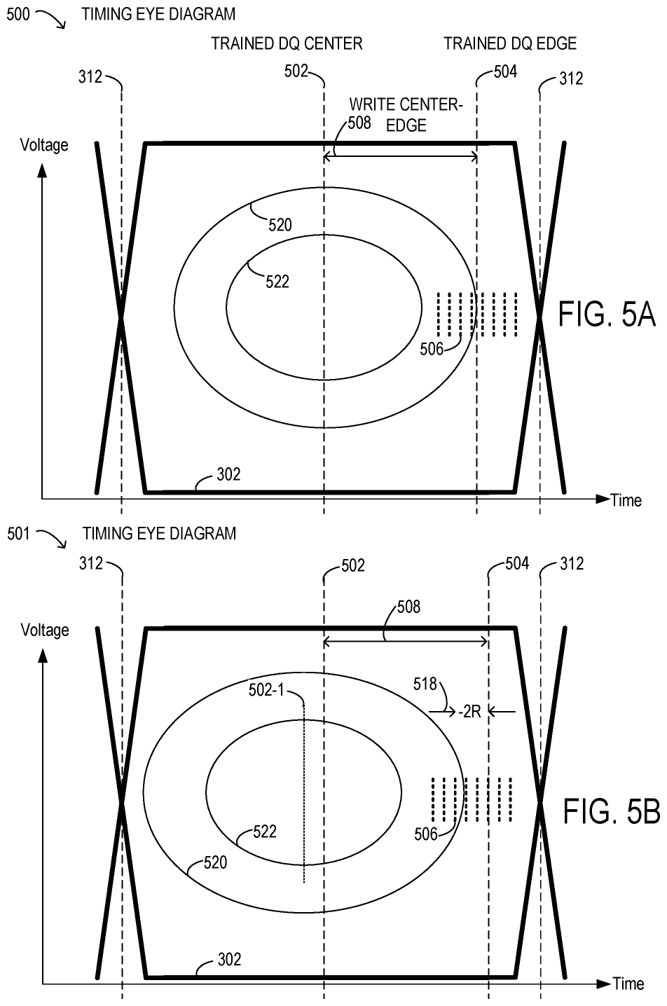

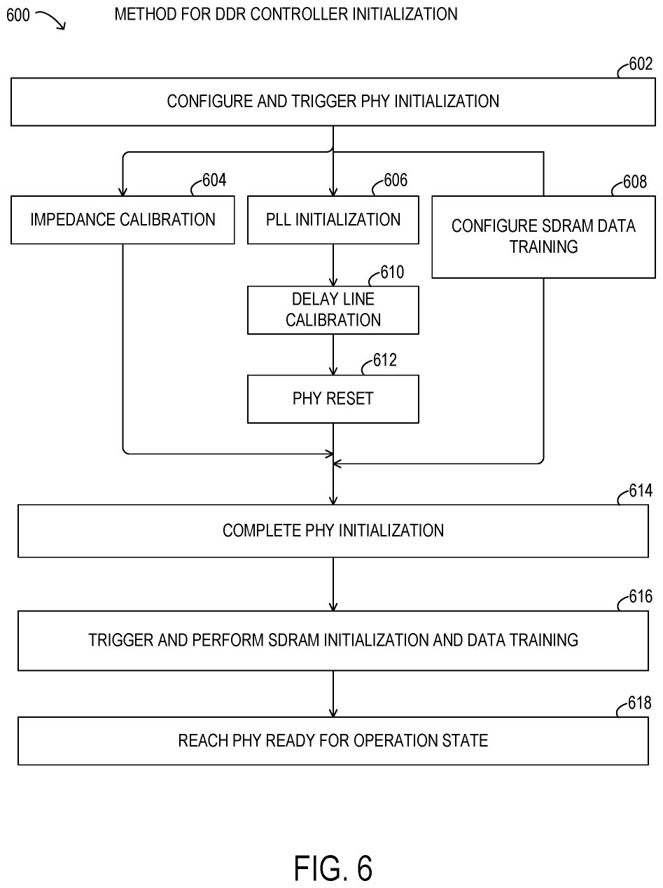

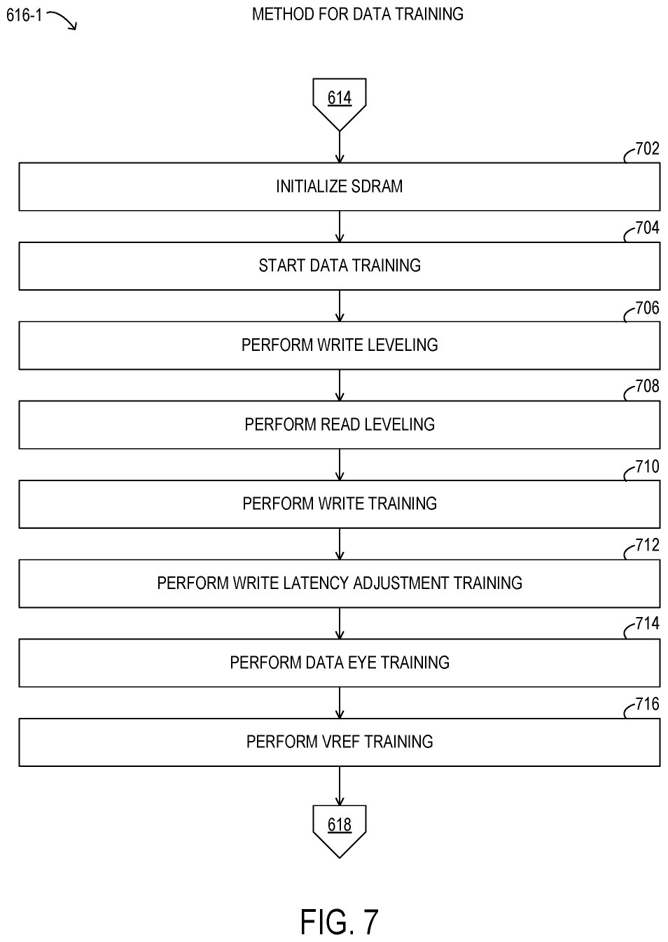

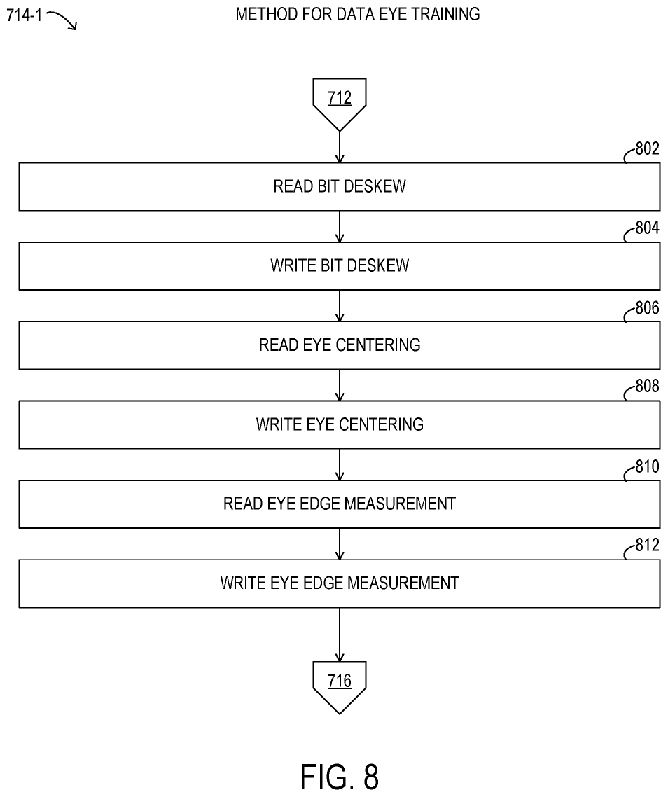

As will be explained in further detail below, DDR interface controller 112 handles a controller initialization sequence involving PHY layer 120 initialization, DDR SDRAM 130 initialization, and data training (see FIG. 6). As used herein, “data training” refers to various operations and steps that allow DDR SDRAM 130 to operate with data integrity (see also FIG. 7). For example, write leveling and read leveling are operations in data training that compensate for timing skew between control clock 211 provided to DDR SDRAM 130 via interface 154 and memory IO clock 302 that can be synthesized internally by DDR SDRAM 130. As shown in FIG. 3, write leveling and read leveling are performed to align a clock edge 310 with a clock transition 312 at DDR SDRAM 130. Additionally, “data eye training” as used herein refers to training sequences that PHY layer 120 may perform to align DQ lanes 132 with memory IO clock 302, such that a timing eye center 314 of memory IO clock 302 is aligned with a DQ center 316 of DQ lanes 132, as can be observed in a data eye diagram, also referred to as a “timing eye diagram” (see FIGS. 4, 5A, and 5B). As will be explained in detail below, data eye training for DDR SDRAM 130 can include read bit deskew 802, write bit deskew 804, read eye centering 806, write eye centering 808, read eye edge measurement 812, and write eye edge measurement 812 (see FIG. 8).

Furthermore, as shown in FIG. 3, DQ lanes 132 (D0 . . . D7) are shown with a monotonically increasing delay starting with D0 132-1. Thus, each DQ center 316-1, 316-2, 316-3, 316-4, 316-5, 316-6, 316-7, 316-8 is monotonically shifted in a successive manner. Each DQ lane 132 is shown in FIG. 3 transmitting eight (8) bits over successive unit intervals (UI0, UI1, UI2, UI3, UI4, UI5, UI6, UI7). As noted, in conventional data eye training operations, such as for data eye centering or data eye edge measurement, different delays are programmed for an entire DQ group 202 (all DQ lanes 132) uniformly, and then test values are read out. Such conventional methods will typically consume several UIs, or a larger number of UIs, that are not available for normal operation, which is undesirable. By applying a monotonically increasing delay to each individual DQ lane 132, using a different delay value for each DQ lane 132, as shown in DDR timing 300 in FIG. 3, such data eye training operations can effectively test or evaluate multiple delay values using one or two UIs, as will be described in further detail herein. In this manner, the use of the monotonically increasing delays within DQ group 202 can be used for periodic training (during operation, after initialization) with low overhead, which is desirable. For example, the delay values for DQ lanes 132 shown in FIG. 3 may correspond to a read test delay 406 with resolution R, as shown in FIGS. 4, 5A, 5B. It is noted that with different numbers of DQ lanes 132 per DQ group 202, such as 16 or 24, different delay timing resolution and delay timing overall intervals can be simultaneously tested and evaluated, according to the methods described herein.

Referring now out of order in the drawings to FIG. 6, a method 600 for DDR controller initialization is depicted in flow chart format. FIGS. 4, 5A, and 5B are discussed below after a description of FIG. 7. It is noted that certain elements in method 600 may be omitted or rearranged in different implementations. In broad terms, an initialization sequence of DDR interface controller 112 can include the following main phases: PHY initialization, DDR SDRAM initialization, and data training. After the initialization sequence has completed without errors, for example, DDR memory subsystem 100 can be in an operational state. In particular implementations, method 600 may generally be used for various DDR systems, such as DDR4, LPDDR4, DDR5, and LPDDR5, while certain aspects and operations in method 600 may be specific to certain DDR types, as explained below.

Method 600 can be performed by DDR interface controller 112 in coordination with PHY layer 120 and DDR SDRAM 130, in particular implementations. However, method 600, along with various methods, functions, and algorithms disclosed herein, can be performed, executed, or implemented using different means, including, but not limited to at least one of: using firmware for execution by a processor or controller enabled to access instructions stored in the firmware, such as firmware 113 executed by DDR controller 112 in memory controller 110, among other firmware; using a particular logic circuit, such as a state machine or other logic circuitry; using an FPGA; or using a data processing system.

As shown in FIG. 6, method 600 can begin at step 602 with configuring and triggering PHY initialization. After deassertion of reset, PHY layer 120 is uninitialized. In step 602, PHY initialization is comprised of initializing clock/PLLs 124, running an initial impedance calibration, and running delay-line calibration, which can be triggered together and then can be run in parallel, as shown by parallel paths in method 600. At step 604, impedance calibration is performed. PHY layer 120 can include calibration I/O cells and finite state machine logic to automatically compensate output drive strength and on-die termination strength, and can adjust impedance in step 604 for variations in process, voltage, and temperature. At step 606, PLL initialization is performed. After triggering reset, PHY layer 120 may wait for PLLs 124 to lock before any further initialization task that uses a high-speed clock, such as control clock 114 control clock 211, memory IO clock 302, or memory clock 136, can commence. At step 610, delay line calibration is performed. After PLLs 124 have locked, PHY layer 120 can execute delay line calibration before any further initialization task that uses high-speed clocking. Each master delay line is calibrated for the SDRAM clock period, such as by measuring a number of delay line steps that are involve for producing a delay equal to a DDR clock period. Each master delay line is calibrated independently. Delay line calibration can be done as part of the PHY initialization sequence. At step 612, PHY reset is asserted. At step 608, SDRAM data training is configured. Various different data training operations can be selected for execution in step 616 (see also FIG. 7). At step 614, initialization of PHY layer 120 is completed. At step 616, SDRAM initialization and data training are triggered and performed (see FIG. 7, step 702). In step 616, DDR interface controller 112 may perform SDRAM initialization. At step 618, PHY layer 120 reaches the ready for operation state.

In FIG. 7, further details of data training in step 616 of method 600 are shown in one implementation of a method 616-1. Accordingly, the steps shown in method 616-1 may be performed after step 614 in method 600. After method 616-1, step 618 in method 600 may be performed. Although method 616-1 can generally be used for various DDR systems, certain aspects of method 616-1 may represent a method of data training for LPDDR, such as LPDDR4 or LPDDR5, as noted. For example, for LPDDR5, instead of DQS strobe 134, read eye training can be used to align a read clock (RDQS) (also referred to as a read data strobe) with DQ lanes 132 for read operations, while write-eye training can be used to align a write clock (WCK) with DQ lanes 132 for write operations (see also FIG. 9).

In FIG. 7, method 616-1 may begin at step 702 by initializing SDRAM. At step 704, data training is started. At step 706, write leveling is performed. For signal integrity reasons, clock, address, and control signals in multiple SDRAM systems can be routed sequentially from one SDRAM to the next. This is called fly-by topology and can help to reduce a number of stubs and their length. The write data and strobe signals can, however, be routed with equal delay to each SDRAM. The fly-by topology can cause skew between the clock and the data strobe, making it difficult for memory controller 110 to maintain timing specification. Write leveling is used to compensate for this skew, for example, by aligning control clock 211 with memory IO clock 302 at each SDRAM. PHY layer 120 can use the write leveling feature, and feedback from the SDRAM, to adjust a timing relationship of clock edge 310 with clock transition 312. Write leveling uses adjustable delay settings on memory IO clock 302 to align clock transition 312 with clock edge 310 that can be provided to a DRAM pin. The DRAM asynchronously feeds back memory IO clock 302 (sampled with clock transition 312) through a DQ bus. Writing leveling repeatedly delays clock transition 312 until a transition from 0 to 1 is detected. In this manner, a delay for is established through write leveling. At step 708, read leveling is performed. Memory IO clock 302 from DDR SDRAM 130 can be gated by PHY layer 120 to suppress noise and correctly capture read data. The precise alignment of the gate to the read data is a prerequisite for proper reads. Since delays, such as board trace lengths in the read path, are often imprecisely known, the gate is trained for a particular system. PHY layer 120 features a built-in read memory IO clock 302 gate training unit that might be triggered as part of the initialization process. Read leveling is an algorithm that works with clock transition 312. Gate and a delayed (by a few LCDL taps) gate sample memory IO clock 302. Gate starts from (a position of delay equal to zero) until the first edge of memory IO clock 302 is found between the two sampling edges of the gate and delayed gate. A final position of the gate is found by adding a programmable (delay) offset to this value.

In method 616-1, at step 710, write DQS2DQ training is performed. Step 710 may be performed specifically on LPDDR memories, such as LPDDR4 in various implementations. LPDDR4 memory devices may use an unmatched DQS-DQ path to enable high-speed performance and save power. As a result, DQS strobe 134 is trained to arrive at the DQ latch center-aligned with the data eye. The DQ receiver latches the data present on the DQ bus when DQS strobe 134 reaches the latch. DQS2DQ training is accomplished by delaying the DQ signals 132 relative to DQS strobe 134 such that the data eye arrives at the receiver latch centered on the DQS transition. DQS to DQ training is referred to as write training in the JEDEC® standard and write DQ training in the DFI standard. At step 712, write latency adjustment training is performed. After write leveling in step 706, DQS strobe 134 is aligned to memory clock 136 at each SDRAM, but it is not known if DQS strobe 134 is aligned to a correct edge of memory clock 136. To clear up this ambiguity, a second level of write leveling is used to determine if extra pipeline stages need to be added in the write path due to the write leveling or the board delays. The write latency adjustment writes a fixed-pattern back-to-back sequence of two BL16s, appended with extra DQS pulses at the end of the last BL16 to obtain a sufficiently long pattern so that nine, previously ambiguous, system write latency situations can be uniquely distinguished. The write leveling algorithm writes this data using a minimal DFI pipeline depth. The distinction is performed by counting a number of one beats in odd and even DQ lines. After determining the write latency, a second sequence of writes and reads are issued to validate the computed latency adjustment setting.

As shown in FIG. 7, method 616-1 proceeds to step 714 in which data eye training is performed. Read bit deskew, write bit deskew, read eye training, and write eye training are included in data eye training. As bit rates increase in successive DDR generations, maintaining timing margins in the DDR interfaces becomes more difficult. The PHY solution includes delay lines to compensate for per-bit skew due to factors such as PHY to I/O routing skews, package skews, and PCB skew. PHY layer 120 can be configured for automatic training sequences to perform read and write deskew, which align the data bits to the DQ bit with the longest delay using bit delay lines (BDL). In this manner, for example, the skew (or timing variance) among DQ lanes 132 in each respective DQ group 202 may be minimized. Further details of data eye training in step 714 are shown and described with respect to FIG. 8.

In method 616-1 of FIG. 7, at step 716 VREF training is performed. The write and read eyes should be as wide as possible to provide a stable and robust memory access. The eye position depends upon LCDL delays, as well as VREF values. The write and read data eye training is used to find out the best eye position by changing LCDL values with an initial calculated and programmed VREF setting. VREF training is used to determine a range of VREF values where memory interface (write and read) is stable and then determine an optimum write and read eye position. Different types of VREF training can be used such as DRAM VREF training to optimize the write eye by sweeping DRAM VrefDQ values inside memory, and host VREF training to optimize the read eye by sweeping PHY layer 120's VREF setting.

In FIG. 8, further details of data eye training in step 714 of method 616-1 are shown in one implementation of a method 714-1. Accordingly, the steps shown in method 714-1 may be performed after step 712 in method 616-1. After method 714-1, step 716 in method 616-1 may be performed. In particular, method 714-1 may represent a method of data training for LPDDR, such as LPDDR4 or LPDDR5, as noted below.

After performing bit deskew, the read eye training and write eye training can be executed to place DQS strobe 134, such as in the case of DDR4, in the center of the eye defined by DQ lanes 132 in the respective byte. For DDR5, such as LPDDR5, read eye training can be used to align a read clock (RDQS) with DQ lanes 132 for read operations, while write-eye training can be used to align a write clock (WCK) with DQ lanes 132 for write operations (see also FIG. 9).

During read eye training or write eye training, each individual DQ lane 132 has a register that contains error and warning status flags for each of the eye training algorithms. Error conditions can be fatal to data eye training and PHY layer 120 can immediately terminate data training when an error condition arises. Within the error and warning register, a bit field contains an error status code. This error status code identifies the sub-step where the failure or error occurred and the algorithm descriptions provide the conditions for the error and the associated error status code. A warning status generally indicates that either the right edges or the left edges of the data eye could not be detected. This can occur for a variety of reasons but may be more likely to occur during write bit deskew or write eye centering. When data eye edge warning occurs, the algorithm has assumed that the edge of the eye has been detected when it has exhausted the available DDL resources. This can result in a skewed center positioning of DQ lanes 132 within the data eye.

In method 714-1 of FIG. 8, data eye training can include read bit deskew at step 802. The read bit deskew algorithm is performed in parallel for DQ lanes 132 and involves write and read access to memory locations in DDR SDRAM 130, such as addressable locations in memory array banks 144 or values in FIFO 139, among other registers in various implementations. A goal of read bit deskew algorithm is to align a 0-to-1 transition on each of DQ lanes 132 in the read path to each other. In some implementations of read bit deskew, an initial pattern can be written into memory, read back, and then evaluated. Then per-bit delay lines are used to align DQ lanes 132 to each other. After deskewing, another read is executed to confirm data integrity.

In method 714-1 of FIG. 8, data eye training can further include write bit deskew at step 804. The write bit deskew algorithm is performed in parallel for DQ lanes 132 and involves write and read access to memory locations in DDR SDRAM 130, such as addressable locations in memory array banks 144 or values in FIFO 139, among other registers in various implementations. A goal of the PHY write bit deskew algorithm is to align a 0-to-1 transition on each of DQ lanes 132 in the write path. An initial pattern is written into memory, read back, and then evaluated. Then per-bit delay lines are used to align DQ lanes 132 to each other. After deskewing, another read is executed to confirm data integrity.

In method 714-1 of FIG. 8, after read bit deskewing at step 802 and write bit deskewing at step 804, the data transitions on each of DQ lanes 132 are presumptively aligned to each other. However, a timing of DQS strobes 134 (or alternatively WCK/RDQS in LPDDR5) may not be aligned with a timing of DQ lanes 132, such that timing eye center 314 may not be aligned with DQ center 316 (see FIG. 3). Thus, in method 714-1, data eye training can further include read eye centering at step 806. The read eye centering algorithm can be performed in parallel for DQ lanes 132 at step 806 in method 714-1 and involves write and read access to memory locations in DDR SDRAM 130, such as addressable locations in memory array banks 144 or values in FIFO 139, among other registers in various implementations. A goal of the PHY read eye centering algorithm is to center DQS strobe 134 (or alternatively RDQS in LPDDR5) within the data eye in each DQ lane 132 in the read path, collectively as DQ group 202. In some implementations of read eye centering, an initial pattern is written into memory, read back, and then evaluated. Since the process of read eye centering can be open ended or iterative, a large number of reads can be involved each time read eye centering is performed. Then, by reading data, DQS lanes 132 are moved to find the left edge and the right edge of the read eye, and the optimal center position or the read eye is calculated. For determining DQ center 316, the initial pattern used for read eye centering in step 806 may include less regular (or more aggressive) data having high variability that is less tolerant to timing variations and that results in relatively high levels of noise and signal interference along the data pipeline, such as a random pattern of 0s and 1s (see also FIG. 4, strong eye mask 410). After centering, another read is executed to confirm data integrity.

In method 714-1 of FIG. 8, data eye training can further include write eye centering at step 808. In method 714-1, at step 808, a write eye centering algorithm can be performed in parallel for DQ lanes 132 and involves write and read access to memory. A goal of the PHY write eye centering algorithm is to center DQS strobe 134 (or alternatively WCK in LPDDR5) within the data eye in each DQ lane 132 in the write path, collectively as DQ group 202. An initial pattern is written into memory, read back, and then evaluated. Since the process of write eye centering can be open ended or iterative, a large number of writes and reads can be involved each time write eye centering is performed. Then, by writing data, DQ lanes 132 are moved to find the left edge and the right edge of the write eye, and the optimal position is calculated. For determining DQ center 316, the initial pattern used for write eye centering in step 808 may include less regular (or more aggressive) data having high variability that is less tolerant to timing variations and that results in relatively high levels of noise and signal interference along the data pipeline, such as a random pattern of 0s and 1s (see also FIG. 4, strong eye mask 410). After centering, another read is executed to confirm data integrity.

As noted above, the data pattern for read eye centering in step 806 and for write eye centering in 808 includes less regular data, corresponding to strong eye mask 410, described below with respect to FIG. 4. Since strong eye mask 410 is a subset of weak eye mask 408, strong eye mask 410 does not reach to desired timing eye edges for reads and writes. Therefore, in method 714-1 of FIG. 8, data eye training can further include read eye edge measurement at step 810 and write eye edge measurement in step 812 that are performed using data used to determine weak eye mask 408 that can be generated using highly regular (or less aggressive) data having low variability that is more tolerant to timing variations and that results in relatively low levels of noise and signal interference along the data pipeline, such as regular byte patterns 00110011 or 01010101. At step 810, for read eye edge measurement, an initial pattern is written into memory, read back, and then evaluated. Since the conventional process of read eye edge measurement can be open ended or iterative, a large number of reads can be involved each time read eye edge measurement is performed. Then, by reading data, DQS lanes 132 are moved to find the left edge and the right edge of the read eye, based on weak eye mask 408. At step 812, for write eye edge measurement, an initial pattern is written into memory (or a FIFO), read back, and then evaluated. Since the conventional process of write eye edge measurement can be open ended or iterative, a large number of writes and reads can be involved each time write eye edge measurement is performed. Then, by writing data, DQ lanes 132 are moved to find the left edge and the right edge of the write, based on weak eye mask 408.

As will be described in further detail, read eye edge measurement in step 810 and write eye edge measurement in step 812 can be repeated for periodic training during operation. For example, in DDR5/LPDDR5, timing parameters for DDR SDRAM 130 can drift over time with voltage and temperature. Therefore, in DDR5/LPDDR5, read response timing of RDQS to DQ lanes 132 is readjusted in periodic training, such as by performing read eye edge measurement in step 810, while a write clock WCK to DQ lanes 132 offset is readjusted in periodic training, such as by performing write eye edge measurement in step 812. As will be described in further detail, in some implementations of step 810, a low-overhead periodic adjustment for memory timing can be performed for read eye edge measurement that involves a singular read operation, for each DQ group 202. As will be described in further detail, in some implementations of step 812, a low-overhead periodic adjustment for memory timing can be performed for write eye edge measurement that involves a singular write operation and a singular read operation for each DQ group 202.

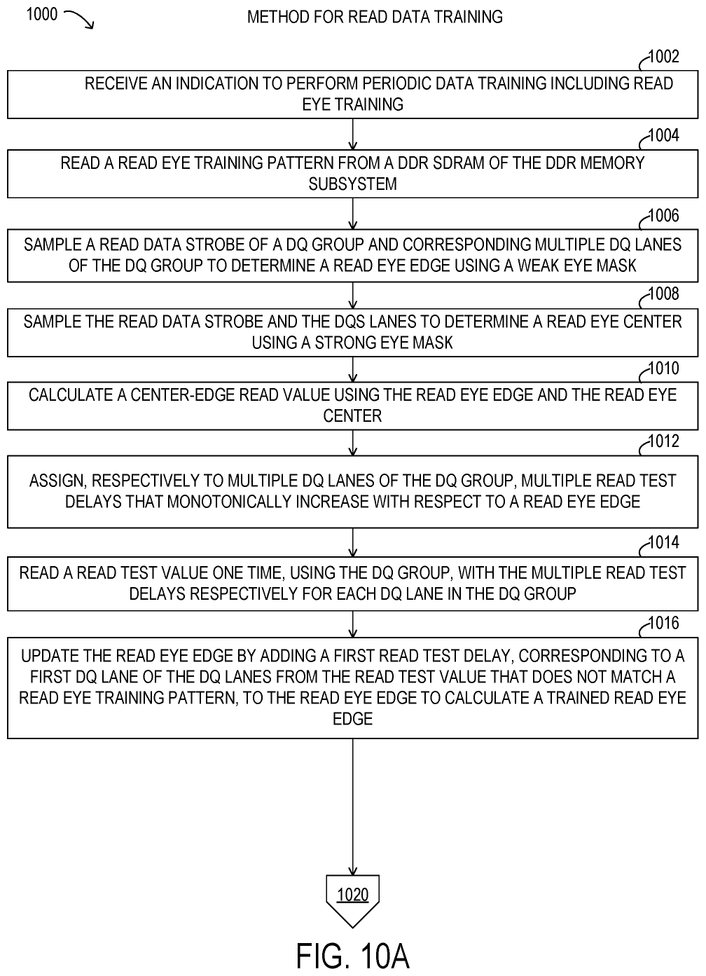

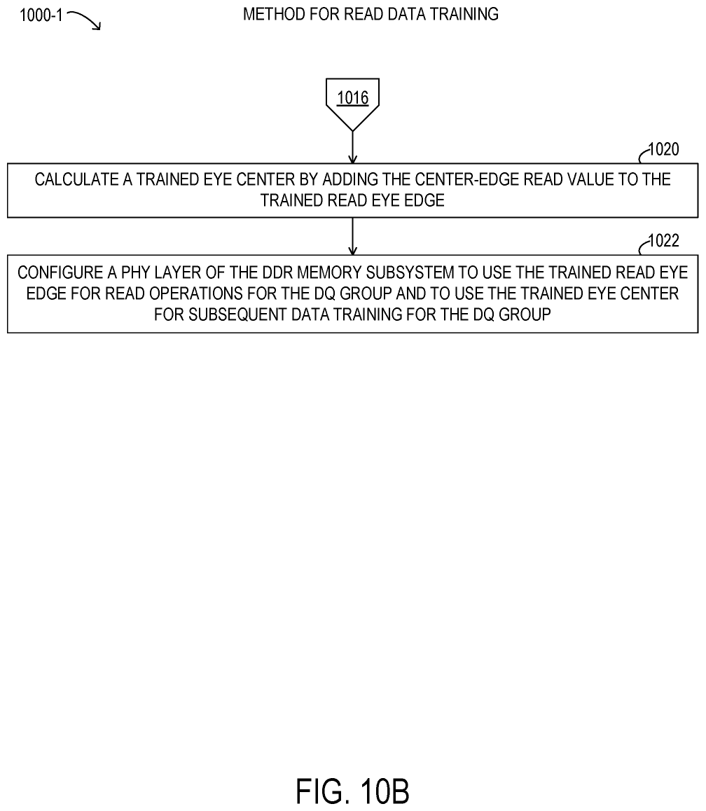

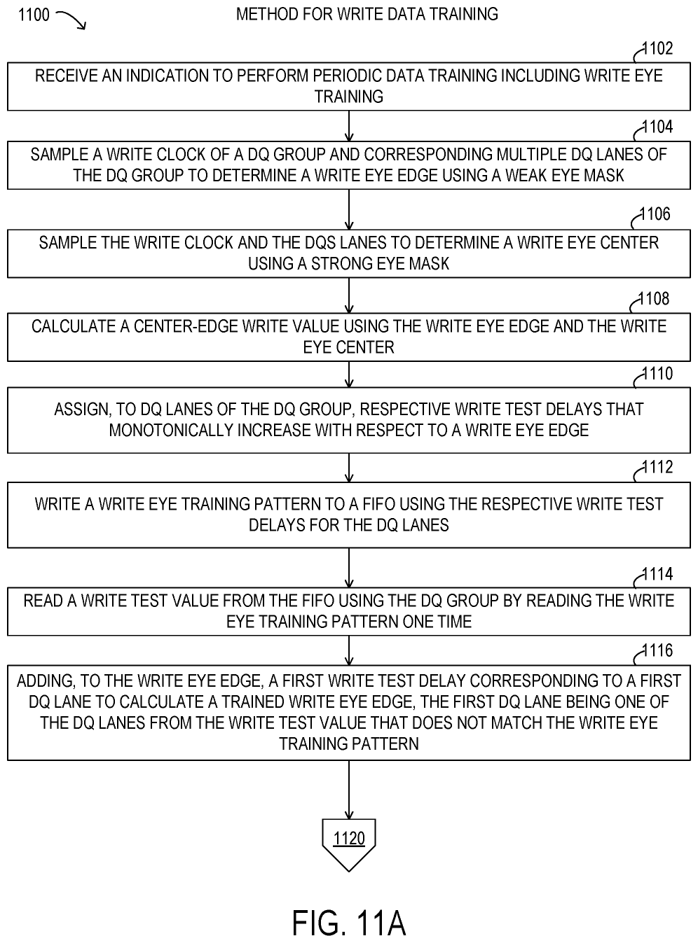

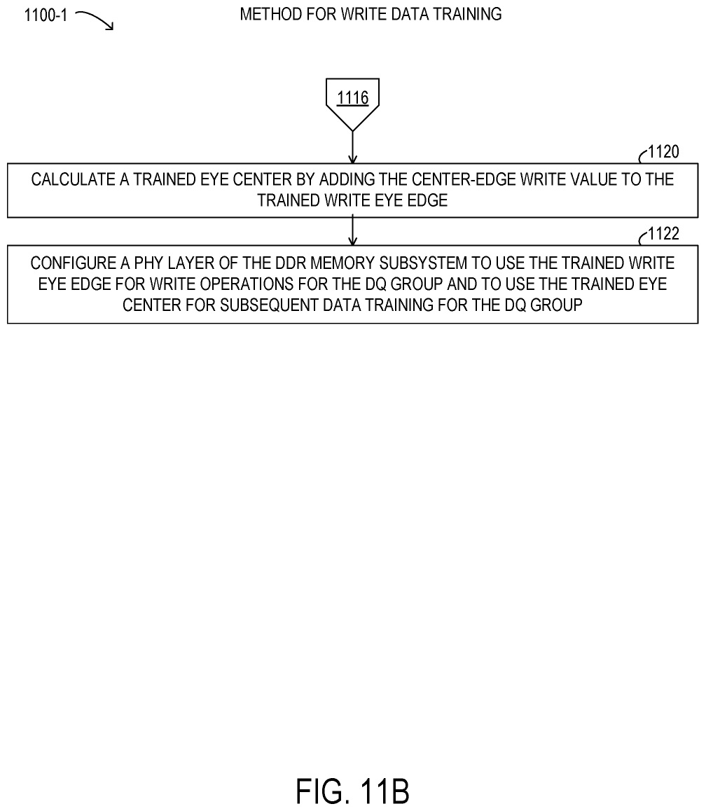

FIG. 9 depicts certain elements of an LPDDR5 system platform 900 (or simply system platform 900). As shown, system platform 900 may represent a particular implementation of system platform 102 in FIG. 1, such as for LPDDR5 memory timing signals. Specifically, PHY utility block 128 may include processing functionality to access and execute code provided by firmware 129 in PHY layer 920, which may be a particular implementation of PHY layer 120 in FIG. 1. For example, PHY utility block 128 can be enabled to execute at least certain portions of method 1000 for read data training and method 1100 for write data training that can be used for periodic training, as disclosed herein (see FIGS. 10 and 11). Accordingly, PHY utility block 128 can be enabled to access and program various delay registers in PHY layer 920 that can be used to adjust timing related to LPDDR5 DRAM 930 data operations, as described herein.

As shown in FIG. 9, a control clock (CK TX) delay 921 can be used to program delays in control clock (CK/CK #) 911. A chip select (CS TX) delay 922 can be used to program delays in a chip select (CS) clock 912. A command address (CA TX) delay 923 can be used to program delays in a command address (CA) clock 913. A write clock (WCK TX) delay 924 can be used to program delays in a write clock (WCK/WCK #) 914 used for write operations to LPDDR5 SDRAM 930. A read data strobe (RDQS RX) delay 925 can be used to program delays in a read data strobe (RDQS/RDQS #) 915. A write data strobe (DQ TX) delay 926 can be used for programming delays for writing data using DQ groups 202. Furthermore, internal clocking 932 may be enabled for providing additional clock management and timing control, such as by providing different UI time bases, for WCK/SCK #914, RDQS/RDQS #915, and DQ groups 202, as shown.

Turning now back to FIG. 4, a timing eye diagram 400 is depicted showing timing features for memory IO clock 302 (or RDQS/RDQS #915) relative to DQ lanes 132 for an 8 lane DQ group 202 (one byte). As noted, although eight (8) DQ lanes 132 are used for DQ group 202 in FIGS. 2, 3, and 4, it is noted that different numbers of DQ lanes 132 (bits) per DQ group 202 and per memory IO clock 302 can be used in different implementations. Timing eye diagram 400 depicts superimposed timing signals of memory IO clock 302 and DQ lanes 132 for 8 lanes, and is also referred to as a “data eye”, or simply an “eye diagram”, in various implementations. As shown, timing eye diagram 400 in FIG. 4 contains signals and data related to read operations for DDR SDRAM 130, and may also be referred to as a “read eye” having a Y axis showing voltage (signal level) and an X axis showing time. It is noted that timing eye diagram 400 is a generalized schematic diagram for descriptive purposes and does not depict actual measured data. Accordingly, timing eye diagram 400 is intended to broadly describe various implementations of data training for different types of DDR memories and for various clock frequencies and data transfer rates.

In timing eye diagram 400 of FIG. 4, memory IO clock 302 is depicted with a true and complementary component as a differential timing clock signal, having clock transition 312 defining an edge as a reference time for each DDR read operation. As described in detail previously, an alignment of clock transition 312 with clock edge 310 of control clock 211 (see also FIG. 3) is performed in data training and is outside the scope of timing eye diagram 400, which is directed to alignment of memory IO clock 302 with respect to DQ lanes 132. Accordingly, the interior portions of timing eye diagram 400 relate to the timing of read data on DQ lanes 132 during read operations for DDR SDRAM 130. Specifically, the timing of actual read data on DQ lanes 132 is indicated by two mask patterns, simply referred to as masks, shown in FIG. 4 as a weak eye mask 408 and a strong eye mask 410. Masks 408, 410 can be sampled prior to, or during, data training operations, respectively for each DQ group 202 and can be stored, such as by PHY layer 120, for retrieval and use in data eye training operations.

As shown in FIG. 4, weak eye mask 408 is a superset of strong eye mask 410 that includes strong eye mask 410, which covers a center portion of weak eye mask 408. Weak eye mask 408 can be generated using highly regular (or less aggressive) data having low variability that is more tolerant to timing variations and that results in relatively low levels of noise and signal interference along the data pipeline, such as regular byte patterns 00110011 or 01010101. In contrast, strong eye mask 410 can be generated using less regular (or more aggressive) data having high variability that is less tolerant to timing variations and that results in relatively high levels of noise and signal interference along the data pipeline, such as a random pattern of 0s and 1s. As noted, weak eye mask 408 and strong eye mask 410 can be generated prior to or during data training and can be retrieved to generate timing eye diagram 400 together with DQS strobe 134. Furthermore, as noted, weak eye mask 408 is used to detect a trained DQ edge 404, while strong eye mask 410 is used to detect a trained DQ center 412.

As shown in FIG. 4, a DQ read delay 402 indicates a timing delay for read operations based on clock transition 312 and may be previously determined during data training, or may represent a current value for read timing delay for DDR SDRAM 130. Accordingly, in timing eye diagram 400, trained DQ edge 404 represents a prior or current value for the read eye edge, trained DQ center 412 represents a prior or current value for the read eye center, while read center-edge 416 represents a prior or current value for the read eye center-edge. However, in the example implementation depicted in timing eye diagram 400, since the prior training, weak eye mask 408 has been observed through data training sampling to have now shifted to the right by a time shift 418, as described below, while strong eye mask 410 has not shifted appreciably. As a result, time shift 418 is used as a read test delay value that is added to DQ read delay 402 to generate a new value (not shown) for DQ read delay 402. Since time shift 418 is negative, the new value for DQ read delay will be smaller than shown in FIG. 4. Furthermore, since strong eye mask 410 has not shifted appreciably, trained DQ center 412 does not shift appreciably. Using the new value for DQ read delay 402, a new value (not shown) for read center-edge 416 is calculated and used to replace the prior or current value.

As described above, typical methods for determining time shift 418 during data training have applied a fixed read delay to all DQ lanes 132 in DQ group 202 used for timing eye diagram 400, and then evaluated all DQ lanes 132 until the new trained read eye edge was discovered. Because the position of the new trained read eye edge is unknown, applying and testing different values for the read delay using typical methods would involve correspondingly multiple read cycles (UIs) for read eye training. Similar constraints also apply to write eye training (see FIGS. 5A and 5B).

Because such a typical method, however, involves numerous iterative read cycles (UIs) using DDR SDRAM 130, a large amount of overhead that reduces operational time can be incurred, which is undesirable. In particular, during periodic training, such large overhead is particularly undesirable and negatively impacts performance of DDR SDRAM 130, particularly when periodic training is more frequently indicated or more frequently useful to maintain tight timing constraints, such as in DDR4, LPDDR4, DDR5, and LPDDR5 implementations, for example. Accordingly, the methods and operations described herein for low-overhead periodic adjustment for memory timing can provide periodic data training, for both read and write operations, that significantly reduces the read and write overhead, respectively, involved with periodic data training. In this manner, the methods and systems described herein for low-overhead periodic adjustment for memory timing can enable a data training regime that involves more frequent data training, thereby preventing excessive drift and timing errors from accumulating, without adversely impacting performance of DDR SDRAM 130, which is desirable.

In FIG. 4, time shift 418 may be determined using low-overhead periodic adjustment for memory timing, as described herein. Specifically, instead of testing a single delay value (e.g. time shift) for the read eye edge of weak eye mask 408 to all DQ lanes 132, a different value for a read test delay 406 (e.g. a training adjustment delay) is used for each individual DQ lane 132 during read eye training. In particular, a set of monotonically increasing values for read test delay 406 can be generated and applied to DQ lanes 132, respectively. The set of monotonically increasing values for read test delay 406 can be assigned successively in order to DQ lanes 132, in particular implementations, as shown in timing eye diagram 400. In other implementations, the set of monotonically increasing values for read test delay 406 can be assigned randomly (not shown) to DQ lanes 132. Furthermore, as shown in timing eye diagram 400, a fixed or regular interval, shown as a resolution (R) 414, may be used between values in the set of monotonically increasing values for read test delay 406 (see also FIG. 3, timing diagram DQ lanes 132). In other implementations, variable or irregular intervals (not shown) may be used between values in the set of monotonically increasing values for read test delay 406. As shown in timing eye diagram 400, both negative and positive values can be used in the set of monotonically increasing values for read test delay 406. In other implementations, negative values or positive values by themselves (not shown) can be used in the set of monotonically increasing values for read test delay 406.

In FIG. 4, as shown in timing eye diagram 400, resolution (R) 414 defines a fixed interval for the set of monotonically increasing values for read test delay 406, and accordingly defines a time resolution of the read eye edge training performed. Although the resolution (R) may be greater than can be achieved using typical methods, the resolution (R) may be sufficient in maintaining adequate timing coherence of DQ lanes 132, such as by providing an upper bound for timing variance that is sufficiently small to maintain adequate or specified timing coherence in DDR SDRAM 130, particularly when periodic training can be performed regularly with low overhead, as disclosed herein. As shown in timing eye diagram 400, the following values for read test delay 406 are applied to DQ lanes 132 for 8 bits: lane D0 is assigned −4R; lane D1 is assigned −3R; lane D2 is assigned −2R; lane D3 is assigned −R; lane D4 is assigned 0; lane D5 is assigned R; lane D6 is assigned 2R; and lane D7 is assigned 3R. In this manner, during read eye edge data training, eight (8) different monotonically increasing values for read test delay 406 can be collectively applied, sampled, and evaluated using one read of one byte (one UI), for example, instead of eight (8) reads (eight UIs) in the typical method, which is desirable for reducing overhead of the read eye edge data training. As shown in timing eye diagram 400, lane D4 is assigned a zero value for read test delay 406 corresponding to alignment with the prior or current value of DQ read delay 402, representing a prior known position of the read eye edge (read edge of weak eye mask 408). However, as indicated above, various different kinds of assignments for read test delay 406 can be used, including assigning delay values that are not aligned with any previous data training values. In the evaluation of time shift 418 observed for weak eye mask 408, as shown in timing eye diagram 400, values for read test delay 406 may be evaluated in decreasing succession starting with a maximum value at lane D7. Then, it is observed that lanes D7, D6, D5, D4, and D3 match a read eye training pattern (not shown) that is used for periodic read training, while lane D2 does not match the read eye training pattern. In particular implementations, the read eye training pattern may correspond to regular or less aggressive read data used to generate weak eye mask 408, such as 00110011 or 01010101, for example. As soon as the mismatch on lane D2 is detected, the value of −R corresponding to lane D3 can be determined for time shift 418, representing a value of read test delay 406. It is noted that −R from trained DQ edge 404 does not perfectly match the new read eye edge in timing eye diagram 400. However, as noted above, the resolution R may be sufficient to maintain timing using the low-overhead method of periodic training that can be regularly performed to maintain timing coherency of DDR SDRAM 130. Accordingly, a value −R is added to trained DQ edge 404 (or R is subtracted) and the resulting value is used to update or replace the prior value of trained DQ edge 404. In some implementations, DQ read delay 402 is stored as a base value, such as obtained from training upon initialization, which does not change until a new initialization is performed, along with a secondary or offset value that is added to the base value, such as upon subsequent periodic training after initialization, such as time shift 418, for example. It is noted that DQ lanes 132 may be randomly or otherwise assigned the monotonically increasing values of read test delay 406, since values of read test delay 406 can be evaluated in decreasing sorted order to obtain time shift 418, as described above. It is further noted that time shift 418 can be sufficiently representative of, and thereby used for all DQ lanes 132 used in timing eye diagram 400.

After the effective value of DQ read delay 402 is updated, the value for read center-edge 416 can also be updated and used for subsequent data training.

Turning now to FIG. 5A, a timing eye diagram 500 is depicted showing timing features for memory IO clock 302 relative to DQ lanes 132 for an 8 lane DQ group 202 (one byte). As noted, although eight (8) DQ lanes 132 are used for DQ group 202 in FIGS. 2, 3, and 4, it is noted that different numbers of DQ lanes 132 (bits) per DQ group 202 and per DQ strobe 134 (not shown) can be used in different implementations, such as 16 or 24 or 32, for example. Timing eye diagram 500 depicts superimposed timing signals of memory IO clock 302 and DQ lanes 132 for 8 lanes, and is also referred to as a “data eye”, or simply an “eye diagram”, in various implementations. As shown, timing eye diagram 400 in FIG. 4 contains signals and data related to write operations for DDR SDRAM 130, and may also be referred to as a “write eye” having a Y axis showing voltage (signal level) and an X axis showing time. It is noted that timing eye diagram 500 is a generalized schematic diagram for descriptive purposes and does not depict actual measured data. Accordingly, timing eye diagram 500 is intended to broadly describe various implementations of data training for different types of DDR memories and for various clock frequencies and data transfer rates.

In timing eye diagram 500 of FIG. 5A, memory IO clock 302 is depicted with a true and complementary component as a differential timing clock signal, having clock transition 312 defining an edge as a reference time to determine a trained DQ center 502 (for writes) that can be used, in turn, for adjusting timing for each DDR write operation, by using a value of a write center-edge 508. As described in detail previously, an alignment of clock transition 312 with clock edge 310 of control clock 211 (see also FIG. 3) is performed in data training and is outside the scope of timing eye diagram 500, which is directed to alignment of memory IO clock 302 with respect to DQ lanes 132. Accordingly, the interior portions of timing eye diagram 500 relate to the timing of write data on DQ lanes 132 during write operations for DDR SDRAM 130. Specifically, the timing of actual write data on DQ lanes 132 is indicated by two mask patterns, simply referred to as masks, shown in FIG. 5A as a weak eye mask 520 and a strong eye mask 522. Masks 520, 522 can be sampled prior to, or during, data training operations, respectively for each DQ group 202 and can be stored, such as by PHY layer 120, for retrieval and use in data training operations. As shown, weak eye mask 520 is a superset of strong eye mask 522 that includes strong eye mask 522, which covers a center portion of weak eye mask 520. Weak eye mask 520 can be generated using highly regular (or less aggressive) data having low variability that is more tolerant to timing variations and that results in relatively low levels of noise and signal interference along the data pipeline, such as regular byte patterns 00110011 or 01010101. In contrast, strong eye mask 522 can be generated using less regular (or more aggressive) data having high variability that is less tolerant to timing variations and that results in relatively high levels of noise and signal interference along the data pipeline, such as a random pattern of 0s and 1s. As noted, weak eye mask 520 and strong eye mask 522 can be generated prior to or during data training and can be retrieved to generate timing eye diagram 500 together with DQS strobe 134. Furthermore, as will be described below, weak eye mask 520 is used to detect a trained DQ edge 504 (for writes), while strong eye mask 522 is used to detect trained DQ center 502, and then respectively calculate write center-edge 508.

As shown in FIG. 5A, a write center-edge 508 indicates a timing delay for write operations based on trained DQ center 502 and may be previously determined during data training, or may represent a current value for write timing delay for DDR SDRAM 130. Accordingly, in timing eye diagram 500, trained DQ edge 504 represents a prior or current value for the write eye edge, trained DQ center 502 represents a prior or current value for the write eye center, while write center-edge 508 represents a prior or current value for the write eye center-edge. In the example implementation depicted in timing eye diagram 500, since the prior training, weak eye mask 520 has been observed through data training sampling to not have, while strong eye mask 410 has also not shifted appreciably. As a result, no time shift is shown or applied in timing eye diagram 500, such that write eye training has validated that the existing write eye timing is coherent for writes using DDR SDRAM 130.

In FIG. 5A, as shown in timing eye diagram 500, write test delay 506 represents substantially similar delay values as described previously with respect to read test delay 406 in FIG. 4. In FIG. 5A, write test delay 506, however, is applied with a zero delay value between lanes D3 and D4 (not labeled in FIG. 5A, see FIG. 4, 406), in one implementation. Upon performance of write eye training, it may be confirmed that write center-edge 508 and trained DQ edge 504 are still valid for DQ write operations, such that no change in write delay values is indicated.

In FIG. 5B, a timing eye diagram 501 is depicted for write operations to DDR SDRAM 130 and is similar to timing eye diagram 500 in FIG. 5B. However, in the example implementation depicted in timing eye diagram 501, since the prior training, weak eye mask 520 has been observed through data training sampling to have now shifted to the left by a time shift 518, as described below, while strong eye mask 522 has shifted a center point from 502 to 502-1. As a result, time shift 518 is used as a write test delay value that is added to trained DQ edge 504 to generate a new value (not shown) for trained DQ edge 504. Since time shift 518 is negative, trained DQ edge 504 will be shifted to the right in FIG. 5A. Furthermore, since strong eye mask 522 has also shifted to the right, trained DQ center 502 is also shifted to the right to a position given by 502-1. Using the new values for trained DQ edge 504 and trained DQ center 502-1, a new value (not shown) for write center-edge 508 is calculated and used to replace the prior or current value.

In FIG. 5B, time shift 518 may be determined using low-overhead periodic adjustment for memory timing, as described herein. Specifically, instead of testing a single delay value (e.g. time shift) for the write eye edge of weak eye mask 520 to all DQ lanes 132, a different value for a write test delay 506 (e.g. a training adjustment delay) is used for each individual DQ lane 132 during write eye training (see also FIG. 3) (see also FIG. 3). In particular, a set of monotonically increasing values for write test delay 506 can be generated and applied to DQ lanes 132, respectively. The set of monotonically increasing values for write test delay 506 can be assigned successively in order to DQ lanes 132, in particular implementations, as shown in timing eye diagram 501. In other implementations, the set of monotonically increasing values for write test delay 506 can be assigned randomly (not shown) to DQ lanes 132. Furthermore, as shown in timing eye diagram 501, a fixed or regular interval (e.g., resolution (R) 414, see FIG. 4) may be used between values in the set of monotonically increasing values for write test delay 506. In other implementations, variable or irregular intervals (not shown) may be used between values in the set of monotonically increasing values for write test delay 506. As shown in timing eye diagram 501, both negative and positive values can be used in the set of monotonically increasing values for write test delay 506. In other implementations, negative values or positive values by themselves (not shown) can be used in the set of monotonically increasing values for write test delay 506.

In FIG. 5B, as shown in timing eye diagram 501, resolution (R) defines a fixed interval for the set of monotonically increasing values for write test delay 506, and accordingly defines a time resolution of the read eye edge training performed. Although the resolution (R) may be greater than can be achieved using typical methods, the resolution (R) may be sufficient in maintaining adequate timing coherence of DQ lanes 132, such as by providing an upper bound for timing variance that is sufficiently small to maintain adequate or specified timing coherence in DDR SDRAM 130, particularly when periodic training can be performed regularly with low overhead, as disclosed herein. As shown in timing eye diagram 501, the following values for write test delay 506 are applied to DQ lanes 132 for 8 bits: lane D0 is assigned −5R; lane D1 is assigned −4R; lane D2 is assigned −3R; lane D3 is assigned −2R; lane D4 is assigned −R; lane D5 is assigned 0; lane D6 is assigned R; and lane D7 is assigned 2R. In this manner, during write eye edge data training, eight (8) different monotonically increasing values for write test delay 506 can be collectively applied, sampled, and evaluated using one read of one byte, for example, instead of eight (8) reads in the typical method, which is desirable for reducing overhead of the write eye edge data training. As shown in timing eye diagram 501, lane D4 is assigned a zero value for write test delay 506 corresponding to alignment with the prior or current value of trained DQ edge 504, representing a prior known position of the write eye edge (write edge of weak eye mask 520). However, as indicated above, various different kinds of assignments for write test delay 506 can be used, including assigning delay values that are not aligned with any previous data training values. In the evaluation of time shift 518 observed for weak eye mask 520, as shown in timing eye diagram 501, values for write test delay 506 may be evaluated in succession starting with a minimum value at lane D7. Then, it is observed that lanes D7, D6, and D5 match a write eye training pattern (not shown) that is used for periodic write training, while lane D4 does not match the write eye training pattern. In particular implementations, the write eye training pattern may correspond to regular or less aggressive read data used to generate weak eye mask 520, such as 00110011 or 01010101, for example. As soon as the mismatch on lane D4 is detected, the value of −2R corresponding to lane D4 can be determined for time shift 518, representing a value of read test delay 506. It is noted that −2R from trained DQ edge 504 does not perfectly match the new write eye edge in timing eye diagram 501. However, as noted above, the resolution R may be sufficient to maintain timing using the low-overhead method of periodic training that can be regularly performed to maintain timing coherency of DDR SDRAM 130. Accordingly, a value −2R is added to trained DQ edge 504 (or 2R is subtracted) and the resulting value is used to update or replace the prior value of trained DQ edge 504. It is noted that DQ lanes 132 may be randomly or otherwise assigned the monotonically increasing values of write test delay 506, since values of write test delay 506 can be evaluated in increasing sorted order to obtain time shift 518, as described above. It is further noted that time shift 518 can be sufficiently representative of, and thereby used for all DQ lanes 132 used in timing eye diagram 501.

After the effective value of trained DQ edge 504 is updated, the value for write center-edge 502-1 can also be updated and used for subsequent data training.

Referring again to the drawings out of order, FIGS. 10A and 10B depict a flowchart of a method 1000 for read data training. Method 1000 can be performed by DDR memory subsystem 100, as described herein, in various implementations. Certain portions of method 1000 may be omitted or rearranged in different implementations.

In FIG. 10A, method 1000 begins, at step 1002, by receiving an indication to perform periodic data training including read eye training. In step 1002, the indication may be associated with a power state change or with DDR memory controller 110. At step 1004, a read eye training pattern stored in a DDR SDRAM of the DDR memory subsystem is identified. At step 1006, a read data strobe of a DQ group and corresponding multiple DQ lanes of the DQ group are sampled to determine a read eye edge using a weak eye mask. At step 1008, the read data strobe and the DQS lanes are sampled to determine a read eye center using a strong eye mask. At step 1010, a center-edge read value is calculated using the read eye edge and the read eye center. At step 1012, multiple read test delays are assigned, respectively to multiple DQ lanes of the DQ group, that monotonically increase with respect to a read eye edge. At step 1014, a read test value is read one time, using the DQ group, with the multiple read test delays respectively for each DQ lane in the DQ group. At step 1016, the read eye edge is updated by adding a first read test delay, corresponding to a first DQ lane of the DQ lanes from the read test value that does not match a read eye training pattern, to the read eye edge to calculate a trained read eye edge. In particular implementations of step 1016 (not shown in FIG. 10A), the DQ lanes are compared in decreasing succession with the read eye training pattern, starting with an initial DQ lane corresponding to a maximum value of the multiple read test delays. After step 1016, method 1000 proceeds to FIG. 10B as method 1000-1.

In FIG. 10B, method 1000-1 proceeds at step 1020 by calculating a trained eye center by adding the center-edge read value to the trained read eye edge. At step 1022, a PHY layer of the DDR memory subsystem is configured to use the trained read eye edge for read operations for the DQ group and to use the trained eye center for subsequent data training for the DQ group.

FIGS. 11A and 11B depict a flowchart of a method 1100 for write data training. Method 1100 can be performed by DDR memory subsystem 100, as described herein, in various implementations. Certain portions of method 1100 may be omitted or rearranged in different implementations.

In FIG. 11A, method 1100 begins, at step 1102, by receive an indication to perform periodic data training including write eye training. In step 1102, the indication may be associated with a power state change or with DDR memory controller 110. At step 1104, a write clock of a DQ group and corresponding multiple DQ lanes of the DQ group are sampled to determine a write eye edge using a weak eye mask. At step 1106, the write clock and the DQS lanes are sampled to determine a write eye center using a strong eye mask. At step 1108, a center-edge write value is calculated using the write eye edge and the write eye center. At step 1110, respective write test delays are assigned to DQ lanes of the DQ group that monotonically increase with respect to a write eye edge. At step 1112, a write eye training pattern is written to a FIFO using the respective write test delays for the DQ lanes. At step 1114, a write test value is read from the FIFO using the DQ group by reading the write eye training pattern one time. At step 1116, a first write test delay corresponding to a first DQ lane is added, to the write eye edge, to calculate a trained write eye edge, the first DQ lane being one of the DQ lanes from the write test value that does not match the write eye training pattern. In particular implementations, step 1116 may include comparing the DQ lanes in succession with the write eye training pattern, starting with an initial DQ lane corresponding to a minimum value of the respective write test delays. After step 1116, method 1100 proceeds to FIG. 11B as method 1100-1.

In FIG. 11B, method 1100-1 proceeds at step 1120 by calculating a trained eye center by adding the center-edge write value to the trained write eye edge. At step 1122, a PHY layer of the DDR memory subsystem is configured to use the trained write eye edge for write operations for the DQ group and to use the trained eye center for subsequent data training for the DQ group.

In an implementation, a memory subsystem may include input/output (I/O) circuitry having a data signal (DQ) group, the DQ group having multiple DQ lanes and a read data strobe, and one or more controllers coupled to the I/O circuitry, the one or more controllers being configured to assign, respectively to multiple DQ lanes of the DQ group, multiple read test delays that monotonically increase with respect to a read eye edge, read a read test value one time, using the DQ group, with the multiple read test delays respectively for each DQ lane in the DQ group, and update the read eye edge by adding a first read test delay, corresponding to a first DQ lane of the DQ lanes from the read test value that does not match a read eye training pattern, to the read eye edge to calculate a trained read eye edge.

The described implementations may also include one or more of the following features. The memory subsystem where the read eye training pattern includes a value of 0011 or 0101. The memory subsystem where the read eye training pattern includes a value of 0011 or 0101. The memory subsystem where the memory subsystem supports DDR5 or LPDDR5, and where the one or more controllers being configured to update the read eye edge further may include the one or more controllers being configured to compare the DQ lanes in decreasing succession with the read eye training pattern, starting with an initial DQ lane corresponding to a maximum value of the multiple read test delays. The memory subsystem where the one or more controllers are further configured to sample the read data strobe and the DQS lanes to determine a read eye center using a strong eye mask, calculate a center-edge read value using the read eye edge and the read eye center, and calculate a trained eye center by adding the center-edge read value to the trained read eye edge. The memory subsystem where the one or more controllers are further configured to configure a PHY layer of the memory subsystem to use the trained read eye edge for read operations for the DQ group and to use the trained eye center for subsequent data training for the DQ group. The memory subsystem where the one or more controllers are further configured to receive an indication to perform periodic data training including read eye training, where the indication is associated with one of a power state change, or a memory controller included in the DDR memory subsystem, read the read eye training pattern from a DDR synchronous dynamic random access memory (SDRAM) of the DDR memory subsystem, and sample the read data strobe and the multiple DQ lanes of the DQ group to determine the read eye edge using a weak eye mask. The memory subsystem where the multiple DQ lanes include at least eight (8) DQ lanes.

In an implementation, a method may include assigning, to DQ lanes of a DQ group having a write clock of a memory, respective write test delays that monotonically increase with respect to a write eye edge, writing a write eye training pattern to a first-in first-out buffer (FIFO) using the respective write test delays for the DQ lanes, reading a write test value from the FIFO using the DQ group by reading the write eye training pattern one time, and adding, to the write eye edge, a first write test delay corresponding to a first DQ lane to calculate a trained write eye edge, the first DQ lane being one of the DQ lanes from the write test value that does not match the write eye training pattern.

The described implementations may also include one or more of the following features. The method where the write eye training pattern includes a value of 0011 or 0101. The method where the memory supports LPDDR5, and where adding, to the write eye edge, the first write test delay further may include comparing the DQ lanes in succession with the write eye training pattern, starting with an initial DQ lane corresponding to a minimum value of the respective write test delays. The method may include sampling the write clock and the DQS lanes to determine a write eye center using a strong eye mask, calculating a center-edge write value using the write eye edge and the write eye center, and calculating a trained eye center using the center-edge write value and the trained write eye edge. The method may include configuring a PHY layer of the memory to use the trained write eye edge for write operations for the DQ group and to use the trained eye center for subsequent data training for the DQ group. The method may include receiving, by a memory controller, an indication to perform periodic data training including write eye training, where the indication is associated with one of a power state change, or the memory controller, and sampling the write clock of the DQ group and corresponding multiple DQ lanes of the DQ group to determine the write eye edge using a weak eye mask. The method where the DQ lanes include at least eight (8) DQ lanes.

In an implementation, a data processing system may include one or more controllers having access to one or more memory media storing instructions executable by the one or more controllers to assign, respectively to multiple DQ lanes of a DQ group having a read data strobe, multiple read test delays that monotonically increase with respect to a read eye edge, read a read test value one time, using the DQ group, with the multiple read test delays respectively for each DQ lane in the DQ group, and update the read eye edge by adding a first read test delay, corresponding to a first DQ lane of the DQ lanes from the read test value that does not match a read eye training pattern, to the read eye edge to calculate a trained read eye edge.

The described implementations may also include one or more of the following features. The data processing system where the read eye training pattern includes a value of 0011 or 0101, and where the DQ lanes include at least eight (8) DQ lanes. The data processing system where one or more controllers are included in a DDR memory subsystem that supports DDR5 or LPDDR5, and where the instructions executable to update the read eye edge further may include instructions executable to compare the DQ lanes in decreasing succession with the read eye training pattern, starting with an initial DQ lane corresponding to a maximum value of the read test delays. The data processing system may include instructions executable to sample the read data strobe and the multiple DQS lanes to determine a read eye center using a strong eye mask, calculate a center-edge read value using the read eye edge and the read eye center, and calculate a trained eye center by adding the center-edge read value to the trained read eye edge. The data processing system may include instructions executable to configure a PHY layer of the DDR memory subsystem to use the trained read eye edge for read operations for the DQ group and to use the trained eye center for subsequent data training for the DQ group. The data processing system may include instructions executable to receive an indication to perform periodic data training including read eye training, where the indication is associated with one of a power state change, or a memory controller included in the DDR memory subsystem, read the read eye training pattern from a DDR synchronous dynamic random access memory (SDRAM) of the DDR memory subsystem, and sample the read data strobe and the multiple DQ lanes of the DQ group to determine the read eye edge using a weak eye mask.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular implementations described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding implementations described herein. Accordingly, the appended claims are intended to include within their scope such processes, machines, manufacture, compositions of matter, means, methods, or steps.

What is claimed is:

1. A memory subsystem comprising:
input/output (I/O) circuitry comprising a data signal (DQ) group, the DQ group having multiple DQ lanes and a read data strobe; and
one or more controllers coupled to the I/O circuitry, the one or more controllers being configured to:
assign, respectively to multiple DQ lanes of the DQ group, multiple read test delays that monotonically increase with respect to a read eye edge;
read a read test value one time, using the DQ group, with the multiple read test delays respectively for each DQ lane in the DQ group; and
update the read eye edge by adding a first read test delay, corresponding to a first DQ lane of the DQ lanes from the read test value that does not match a read eye training pattern, to the read eye edge to calculate a trained read eye edge.

2. The memory subsystem of claim 1, wherein the read eye training pattern includes a value of 0011 or 0101.

3. The memory subsystem of claim 1, wherein the memory subsystem supports DDR5 or LPDDR5, and wherein the one or more controllers being configured to update the read eye edge further comprises the one or more controllers being configured to:
compare the DQ lanes in decreasing succession with the read eye training pattern, starting with an initial DQ lane corresponding to a maximum value of the multiple read test delays.

4. The memory subsystem of claim 1, wherein the one or more controllers are further configured to:
sample the read data strobe and the DQS lanes to determine a read eye center using a strong eye mask;
calculate a center-edge read value using the read eye edge and the read eye center; and
calculate a trained eye center by adding the center-edge read value to the trained read eye edge.

5. The memory subsystem of claim 4, wherein the one or more controllers are further configured to:
configure a PHY layer of the memory subsystem to use the trained read eye edge for read operations for the DQ group and to use the trained eye center for subsequent data training for the DQ group.

6. The memory subsystem of claim 1, wherein the one or more controllers are further configured to:
receive an indication to perform periodic data training including read eye training, wherein the indication is associated with one of: a power state change; or a memory controller included in the memory subsystem;
read the read eye training pattern from a dual data rate (DDR) synchronous dynamic random access memory (SDRAM) of the memory subsystem; and
sample the read data strobe and the multiple DQ lanes of the DQ group to determine the read eye edge using a weak eye mask.

7. The memory subsystem of claim 1, wherein the multiple DQ lanes include at least eight (8) DQ lanes.

8. A method comprising:
assigning, to DQ lanes of a DQ group having a write clock of a memory, respective write test delays that monotonically increase with respect to a write eye edge;
writing a write eye training pattern to a first-in first-out buffer (FIFO) using the respective write test delays for the DQ lanes;
reading a write test value from the FIFO using the DQ group by reading the write eye training pattern one time; and
adding, to the write eye edge, a first write test delay corresponding to a first DQ lane to calculate a trained write eye edge, the first DQ lane being one of the DQ lanes from the write test value that does not match the write eye training pattern.

9. The method of claim 8, wherein the write eye training pattern includes a value of 0011 or 0101.

10. The method of claim 8, wherein the memory supports LPDDR5, and wherein adding, to the write eye edge, the first write test delay further comprises:
comparing the DQ lanes in succession with the write eye training pattern, starting with an initial DQ lane corresponding to a minimum value of the respective write test delays.

11. The method of claim 8, further comprising:
sampling the write clock and the DQS lanes to determine a write eye center using a strong eye mask;
calculating a center-edge write value using the write eye edge and the write eye center; and
calculating a trained eye center using the center-edge write value and the trained write eye edge.

12. The method of claim 11, further comprising:
configuring a PHY layer of the memory to use the trained write eye edge for write operations for the DQ group and to use the trained eye center for subsequent data training for the DQ group.

13. The method of claim 8, further comprising:
receiving, by a memory controller, an indication to perform periodic data training including write eye training, wherein the indication is associated with one of: a power state change; or the memory controller; and
sampling the write clock of the DQ group and corresponding multiple DQ lanes of the DQ group to determine the write eye edge using a weak eye mask.

14. The method of claim 8, wherein the DQ lanes include at least eight (8) DQ lanes.

15. A data processing system comprising:
one or more controllers having access to one or more memory media storing instructions executable by the one or more controllers to:
assign, respectively to multiple DQ lanes of a DQ group having a read data strobe, multiple read test delays that monotonically increase with respect to a read eye edge;
read a read test value one time, using the DQ group, with the multiple read test delays respectively for each DQ lane in the DQ group; and
update the read eye edge by adding a first read test delay, corresponding to a first DQ lane of the DQ lanes from the read test value that does not match a read eye training pattern, to the read eye edge to calculate a trained read eye edge.

16. The data processing system of claim 15, wherein the read eye training pattern includes a value of 0011 or 0101, and wherein the DQ lanes include at least eight (8) DQ lanes.

17. The data processing system of claim 15, wherein one or more controllers are included in a DDR memory subsystem that supports DDR5 or LPDDR5, and wherein the instructions executable to update the read eye edge further comprise instructions executable to:
compare the DQ lanes in decreasing succession with the read eye training pattern, starting with an initial DQ lane corresponding to a maximum value of the read test delays.

18. The data processing system of claim 17, further comprising instructions executable to:
sample the read data strobe and the multiple DQS lanes to determine a read eye center using a strong eye mask;
calculate a center-edge read value using the read eye edge and the read eye center; and
calculate a trained eye center by adding the center-edge read value to the trained read eye edge.

19. The data processing system of claim 18, further comprising instructions executable to:
configure a PHY layer of the memory subsystem to use the trained read eye edge for read operations for the DQ group and to use the trained eye center for subsequent data training for the DQ group.

20. The data processing system of claim 17, further comprising instructions executable to:
receive an indication to perform periodic data training including read eye training, wherein the indication is associated with one of: a power state change, or a memory controller included in the memory subsystem;
read the read eye training pattern from a DDR synchronous dynamic random access memory (SDRAM) of the memory subsystem; and
sample the read data strobe and the multiple DQ lanes of the DQ group to determine the read eye edge using a weak eye mask.
